(19) United States
(12) Patent Application Publication
(10) Pub. No.: US 2010/0173091 A1
(43) Pub. Date: Jul. 8, 2010

(54) PAINTING APPARATUS AND METHOD OF USE

(76) Inventor: Susie Reis, Burnsville, MN (US)

Correspondence Address: TILLMAN WRIGHT, PLLC, P.O. BOX 49309, CHARLOTTE, NC, 28277-0076, US

(21) Appl. No.: 12/631,401

(22) Filed: Dec. 4, 2009

Related U.S. Application Data
(60) Provisional application No. 61/120,508, filed on Dec. 8, 2008.

(51) Int. Cl. B05D 1/28; B05C 1/00

(52) U.S. Cl. 427/429; 118/200; 118/264

(57) ABSTRACT

A painting apparatus for applying paint to a painting surface within a narrow space includes a handle portion for grasping by a user, an applicator portion attached to the handle portion, and an applicator material for applying paint to the painting surface. The applicator portion has first and second surfaces oriented opposite one another, and the applicator material is arranged relative to at least one of the first and second surfaces of the applicator portion. The applicator portion is offset from the handle portion so as to permit the user to access and paint the painting surface without the user's hand entering into direct contact with the painting surface.

### CROSS-REFERENCE TO RELATED APPLICATION

The present application is a U.S. nonprovisional patent application of, and claims priority under 35 U.S.C. §119(e) to, U.S. provisional patent application Ser. No. 61/120,508, filed Dec. 8, 2008, which provisional patent application is expressly incorporated by reference herein. A copy of U.S. provisional patent application Ser. No. 61/120,508, filed Dec. 8, 2008, is attached hereto as Appendix A, which is likewise expressly incorporated by reference herein.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention generally relates to paint application devices. More particularly, the invention relates to a painting apparatus and method of use in connection with painting within narrow spaces.

In certain situations it is desirable to mount objects close to surfaces to minimize the portion of the location in which the object is located that is occupied by the object. An example of one such object is a toilet. It is possible to mount the toilet close to a wall because it is generally not necessary to access the portion of the wall that is behind the toilet. One of the primary times that it is necessary to access the space behind the toilet is when decorating. For example, it is generally desirable to paint the space behind the toilet when painting other portions of the wall that are not behind the toilet.

While conventional painting implements such as rollers and paint brushes may be used on the other portions of the wall that are not behind the toilet, the toilet is typically located sufficiently close to the wall such that it is not possible to access all of the space that is behind the toilet with a conventional roller or paint brush. To overcome this limitation, it is common to disconnect at least a portion of the toilet to facilitate painting behind the toilet. A problem with disconnecting a portion of the toilet is that it may be necessary to have the portion of the toilet disconnected by a plumber because the toilet contains water and drain lines. Any water and/or waste that inadvertently escapes from the toilet may not only cause damage to the areas that surround the toilet, but also could present a health risk.

A need exists for improvement in paint application devices. This, and other needs, are addressed by one or more aspects of the present invention.

### SUMMARY OF THE INVENTION

The present invention includes many aspects and features. Moreover, while many aspects and features relate to, and are described in, the context of paint application devices for painting within narrow spaces, the present invention is not limited to use only in connection with such devices, as will become apparent from the following summaries and detailed descriptions of aspects, features, and one or more embodiments of the present invention.

Broadly defined, the present invention according to a first aspect is a thin painting system that facilitates painting surfaces that are at least partially behind objects such as toilets, where the object is relatively close to the surface that is to be painted.

Broadly defined, the present invention according to a second aspect is a painting apparatus for applying paint to a painting surface within a narrow space. The painting apparatus includes a handle portion for grasping by a user, an applicator portion attached to the handle portion and having first and second external surfaces oriented opposite one another, and an applicator material arranged relative to at least one of the first and second external surfaces of the applicator portion for applying paint to the painting surface. The applicator portion is offset from the handle portion so as to permit the user to access and paint the painting surface without the user's hand entering into direct contact with the painting surface.

In features of this aspect, the applicator portion may have a length between about 6 inches and about 36 inches; the applicator portion may have a length between about 12 inches and about 18 inches; the applicator portion may have a width between about 1 inch and about 2 inches; the applicator portion may be formed of a metal-based material; the metal-based material may include stainless steel; the applicator material may include foam; the applicator material may include bristles; the applicator material may include a fabric material; and the applicator material may include at least two applicator regions each including a different material.

In further features of this aspect, the applicator material may be permanently attached to the applicator portion; the applicator material may be removably attached to the applicator portion; the applicator material may be removably attached to the applicator portion with an adhesive; the applicator material may be removably attached to the applicator portion with hook and loop fasteners; and at least a portion of the applicator material may be extendable over at least a portion of the applicator portion and slidable relative to the applicator portion such that sliding the applicator material relative to the applicator portion facilitates attachment or detachment of the applicator material.

In still further features of this aspect, the handle portion may be offset from the applicator portion by a distance between about 1 inch and about 3 inches; and the painting apparatus may further include at least one rib extending along at least a portion of the length of the applicator portion.

Broadly defined, the present invention according to a third aspect is a painting apparatus for applying paint to a painting surface within a narrow space. The painting apparatus includes a handle portion for grasping by a user, an applicator portion attached to the handle portion and having first and second external surfaces oriented opposite one another, an applicator material arranged relative to at least one of the first and second external surfaces of the applicator portion for applying paint to the painting surface, and a reinforcing member extending along at least a portion of the applicator portion to provide rigidity along the length thereof. The applicator portion is offset from the handle portion so as to permit the user to access and paint the painting surface without the user's hand entering into direct contact with the painting surface.

Broadly defined, the present invention according to a fourth aspect is a method of painting a surface to be painted within a narrow space. The method includes the steps of providing a painting apparatus having a handle portion and an applicator portion offset from the handle portion, wherein an applicator material is arranged relative to at least one external surface of the applicator portion; immersing at least a portion of the applicator material in a paint reservoir; and positioning the applicator material on the surface to be painted and moving the painting apparatus relative to the surface to be painted so as to cause paint to be applied to the surface to be painted.

In an additional feature of this aspect, the painting apparatus may be used to paint a surface located at least partially behind a toilet.

In addition to the aforementioned aspects and features of the present invention, it should be noted that the present invention further encompasses the various possible combinations and subcombinations of such aspects and features.

### BRIEF DESCRIPTION OF THE DRAWINGS

One or more preferred embodiments of the present invention now will be described in detail with reference to the accompanying drawings, which are not necessarily to scale, wherein the same elements are referred to with the same reference numerals, and wherein,

FIG. 1 is a perspective view of an embodiment of a painting apparatus in accordance with one or more aspects of the present invention;

FIG. 2 is another perspective view of the painting apparatus of FIG. 1;

FIG. 3 is a top view of the painting apparatus of FIG. 1;

FIG. 4 is a side view of the painting apparatus of FIG. 1;

FIGS. 5-9 are environmental views depicting the painting apparatus of FIG. 1 in a method of use; and

FIGS. 10-11 are perspective views of the painting apparatus of FIG. 1 with a paint reservoir.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its implementations, or uses.

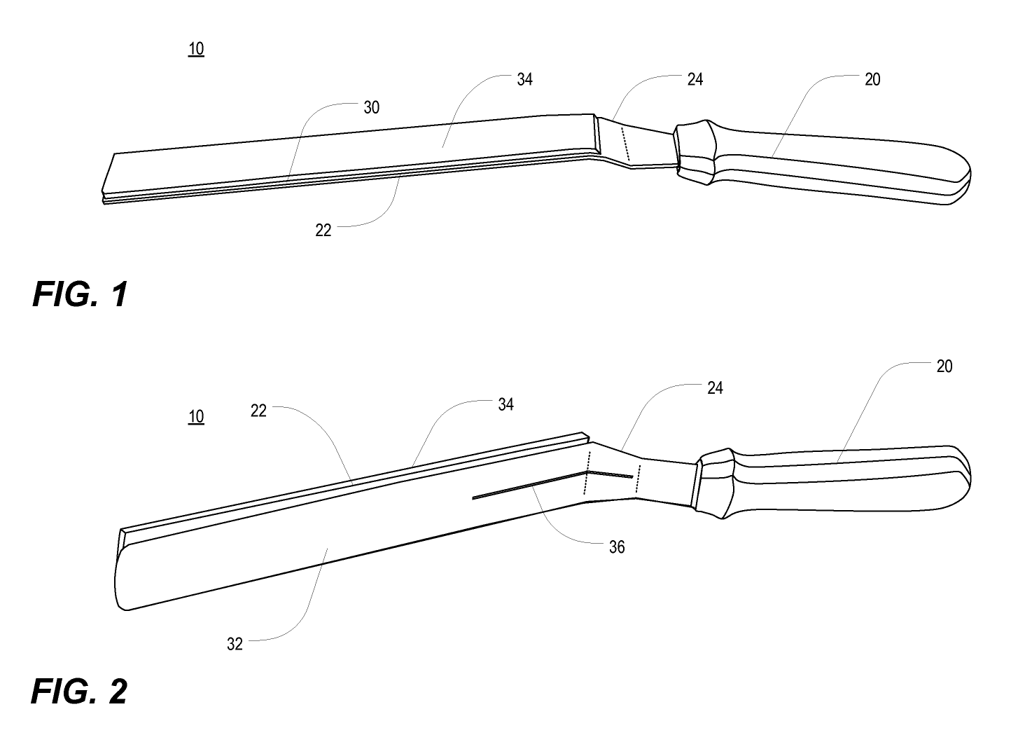

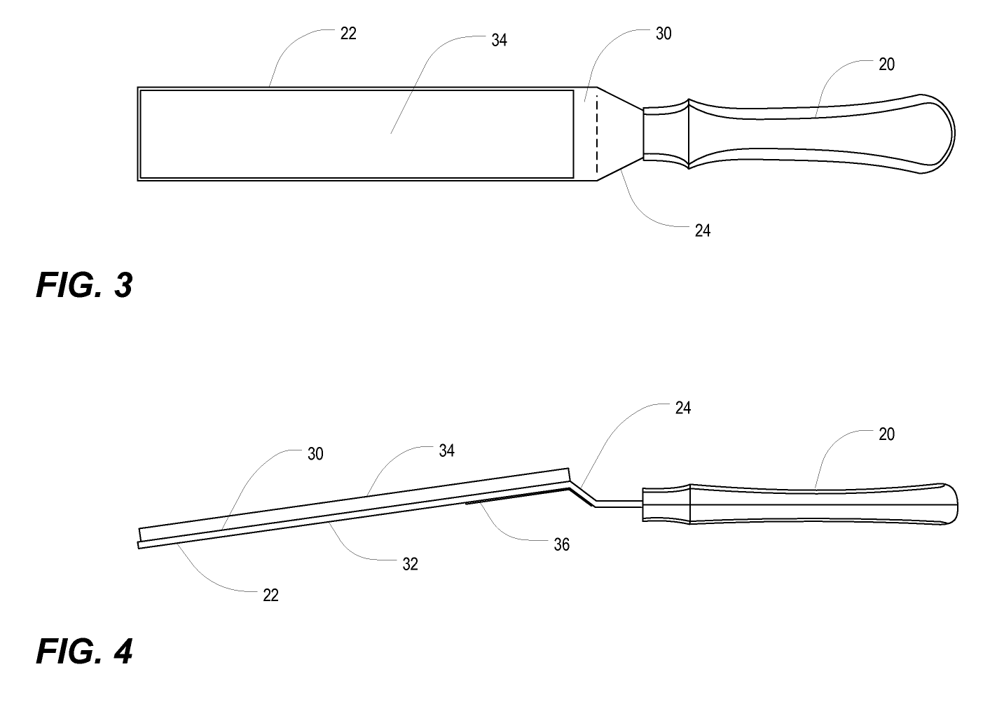

FIG. 1 is a perspective view of a preferred embodiment of a painting apparatus 10 in accordance with one or more aspects of the present invention. FIG. 2 is another perspective view of the painting apparatus 10 of FIG. 1; FIG. 3 is a top view of the painting apparatus 10 of FIG. 1; and FIG. 4 is a side view of the painting apparatus 10 of FIG. 1. The painting apparatus 10 aids in the application of paint to surfaces that are blocked or obstructed by objects placed close to the surfaces, such as toilets, stoves and refrigerators. Many such objects are very heavy or permanently mounted, and therefore difficult or impossible to move. As shown in FIGS. 1-4, the painting apparatus 10 comprises a handle portion 20, an applicator portion 22 and an intermediate portion 24.

In at least one embodiment, the handle portion 20 includes an elongated region configured to be grasped by a user of the painting apparatus 10. The elongated region may be formed with a length, width and outer surface contour to at least partially conform to the shape of the user's hand when closed. The handle portion 20 may be fabricated from the same material as the other components of the painting apparatus 10. Alternatively, the handle portion 20 may be fabricated from a material such as molded plastic.

The applicator portion 22 has a first surface 30 and a second surface 32 oriented opposite each other. In at least one embodiment, the first surface 30 is substantially flat and is adapted to receive an applicator material 34. It will further be appreciated that various embodiments of the applicator portion 22 are of varying lengths. The difference in length of the applicator portion 22 depends on the size of the object behind which the user desires to paint. In at least one embodiment, the applicator portion 22 is between about 12 inches and about 18 inches. However, other embodiments may feature an applicator portion 22 as short as about 6 inches and as long as about 36 inches.

Depending on the length of the applicator portion 22 and the material from which the applicator portion 22 is formed, it may be necessary to strengthen the applicator portion 22 to ensure that an end of the applicator portion 22 that is opposite the handle portion 20 is sufficiently rigid to cause the paint to be applied to the surface. An example of one such device that may be used to strengthen the applicator portion 22 is at least one rib 36 that extends from the second surface 32 along at least a portion of a length of the applicator portion 22.

The applicator portion 22 may be formed with a width that depends on factors such as the size of the object behind which it is desired to paint and the volume of paint that is desired to be held with the applicator material 34. For example, the wider the applicator material 34, the more paint that may be held in the applicator material 34, which reduces the frequency at which the applicator material 34 must be refilled with paint. In at least one embodiment, the width of the applicator portion 22 is about 6 inches. In alternative embodiments, the width is smaller, even as small as about 1 inch.

The applicator portion 22 may be formed from a variety of materials using the concepts of the invention. In some embodiments, the applicator portion 22 may be formed from a metallic material such as stainless steel. Forming the applicator portion 22 from stainless steel enables the applicator portion 22 to be relatively rigid and relatively thin.

The applicator material 34 may be formed from a variety of materials using the concepts of the invention such that the applicator material 34 is relatively thin and has the ability to absorb paint to facilitate applying the paint to the surface. In some embodiments, the applicator material 34 may be foam, bristles, fabric or some combination thereof. In some embodiments, the applicator material 34 has a surface covering that is consistent over the entire surface thereof. In other embodiments, the applicator material 34 may have at least two applicator regions that are fabricated from different materials.

The applicator material 34 may be attached to the applicator portion 22 using a variety of techniques. In some embodiments, the applicator material 34 is permanently attached to the applicator portion 22. Using such a configuration, the painting apparatus 10 may be disposed of after use. In other embodiments, the applicator material 34 may be removably attached to the applicator portion 22. An example of suitable techniques for removably attaching the applicator material 34 is an adhesive or a hook and loop fastener such as is available under the designation VELCRO.

Alternatively or additionally, a portion of the applicator material 34 may extend over at least a portion of the applicator portion 22 such that sliding of the applicator material 34 with respect to the applicator portion 22 facilitates attachment of or detachment of the applicator material 34 to the applicator portion 22. In such a configuration, a lock mechanism may be provided to retain the applicator material 34 in a desired location with respect to the applicator portion 22.

The intermediate portion 24 may offset the handle portion 20 from applicator portion 22 such that when the applicator portion 22 is positioned along a surface for applying paint to the surface, the handle portion 20 is located above the surface such that the user's hand does not contact the surface. In some embodiments, the offset between the handle portion 20 and the applicator portion 22 is up to about 6 inches. In other embodiments, the offset between the handle portion 20 and the applicator portion 22 is between about 1 inch and about 3 inches. The intermediate portion 24 may be oriented at an angle with respect to the applicator portion 22. In some embodiments, the angle may be between about 20 and about 90 degrees.

The handle portion 20, the applicator portion 22 and the intermediate portion 24 may be oriented in different configurations. Examples of alternative configurations provide the painting apparatus 10 with a C-shape or an L-shape.

The intermediate portion 24 may be integrally formed with at least one of the handle portion 20 and the applicator portion 22. The intermediate portion 24 may have sufficient rigidity such that when a pressure is applied to the applicator portion 24 with the handle portion 20, the intermediate portion 24 resists deformation.

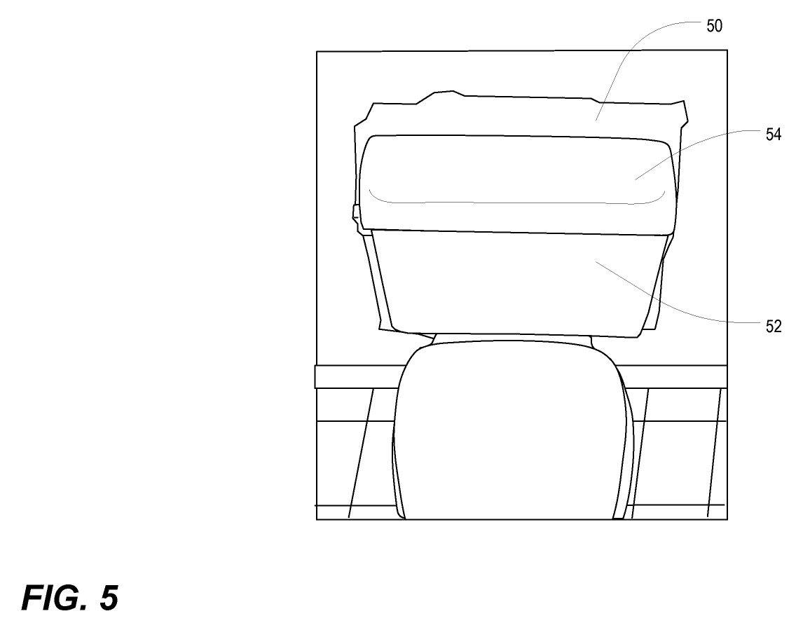

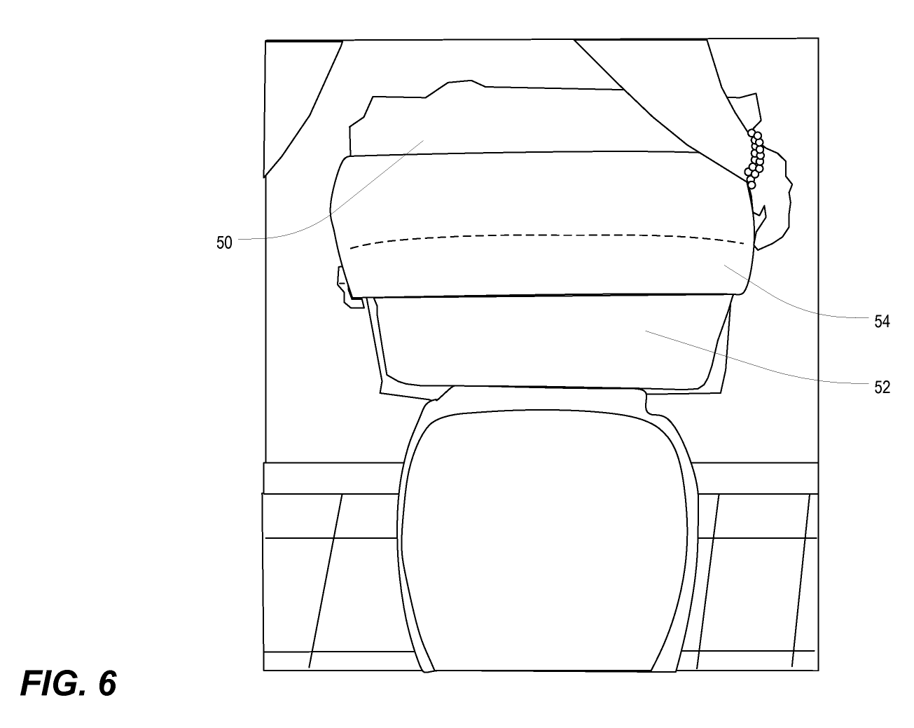

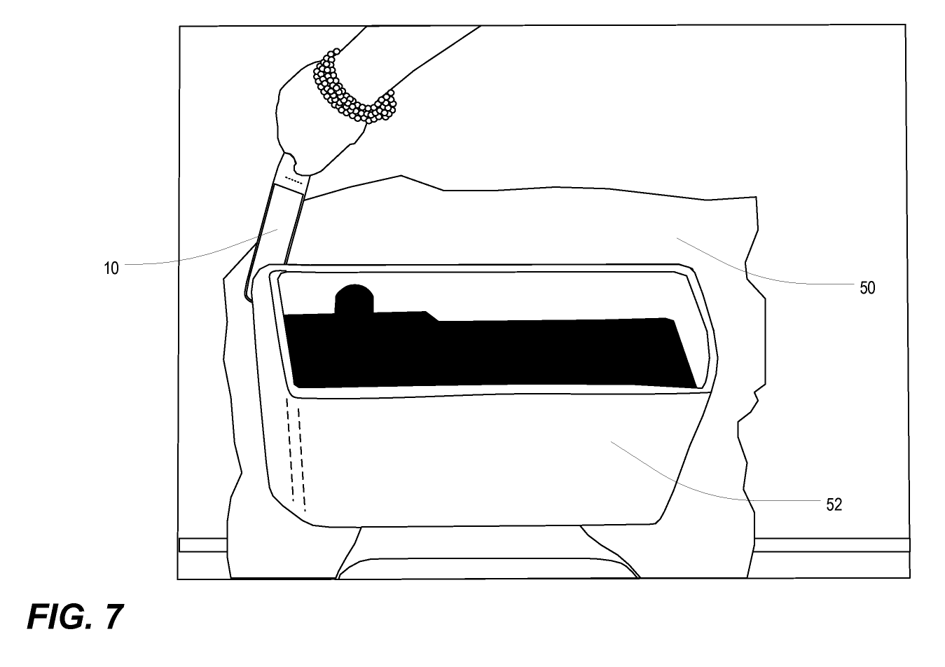

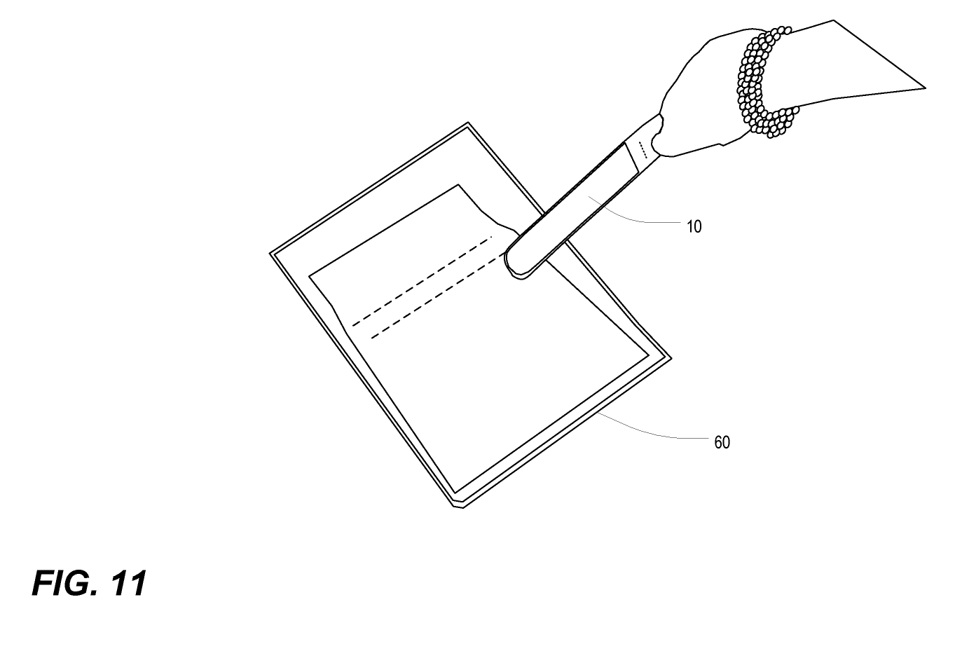

FIGS. 5-9 are environmental views depicting the painting apparatus 10 of FIG. 1 in a method of use, and FIGS. 10-11 are perspective views of the painting apparatus 10 of FIG. 1 with a paint reservoir 60. While FIGS. 5-9 depict the painting apparatus 10 in a method of use to paint behind a toilet 52, it is also contemplated that the painting apparatus 10 may be used in a similar manner to paint other areas that may be difficult to access with conventional paint application devices, such as behind stoves and refrigerators. As shown in FIG. 5, a portion of a surface 50 that is not behind a toilet 52 may be painted using the painting apparatus 10. Alternatively, the painting apparatus 10 may be used to paint the surface 50 that is behind the toilet 52 before the other portions of the surface 50 are painted.

In an initial step, a top 54 of the toilet 52 may be removed, as shown in FIG. 6. The toilet 52 may be covered with a protective material such as a sheet of plastic. As shown in FIG. 10, the applicator material 34 is at least partially immersed in a paint reservoir 60 to cause the paint to be retained therein. If the applicator material 34 soaks up excess paint, the applicator material 34 may be moved across an edge of a paint reservoir 60, as shown in FIG. 11, so as to remove some of the paint from the applicator material 34.

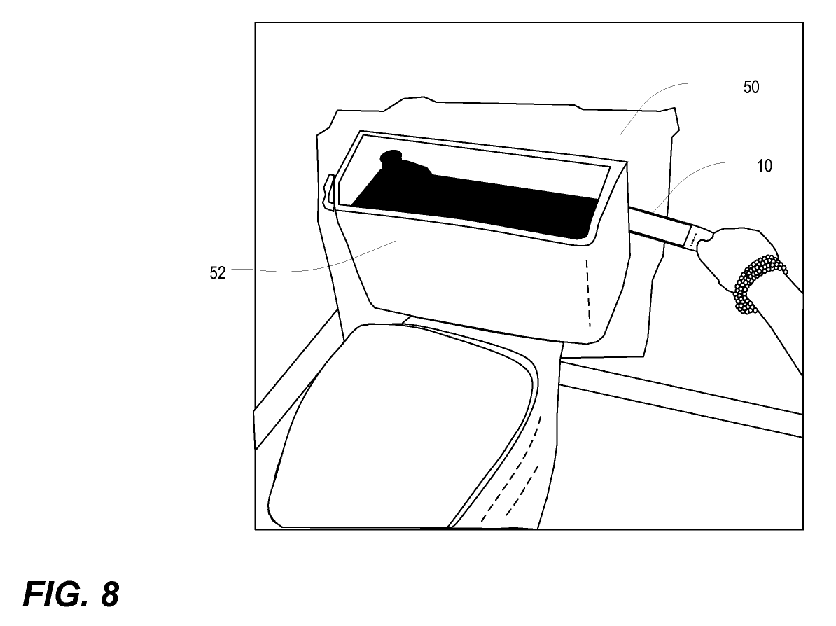

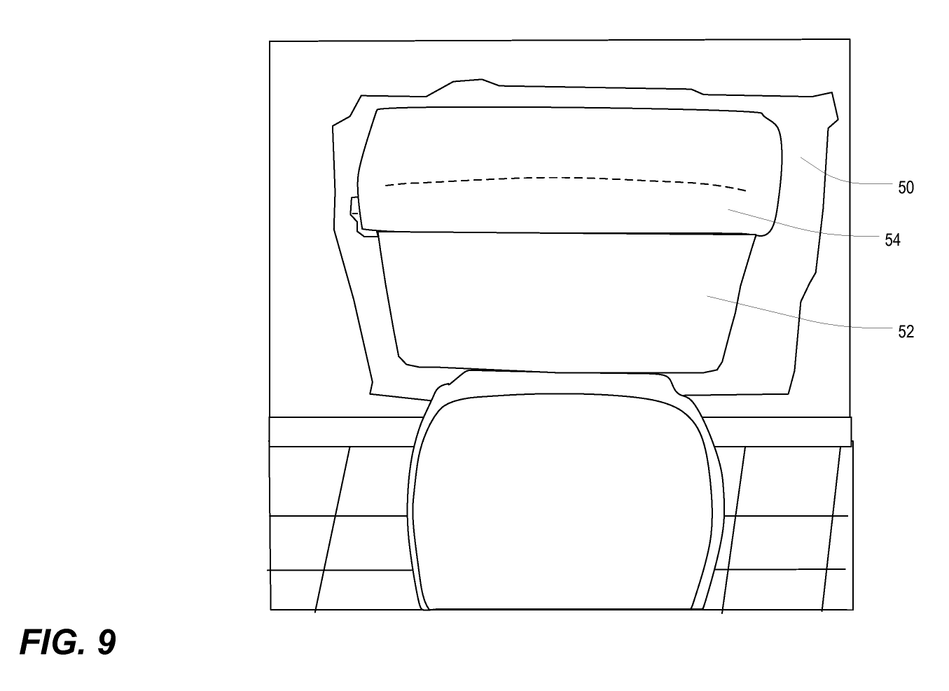

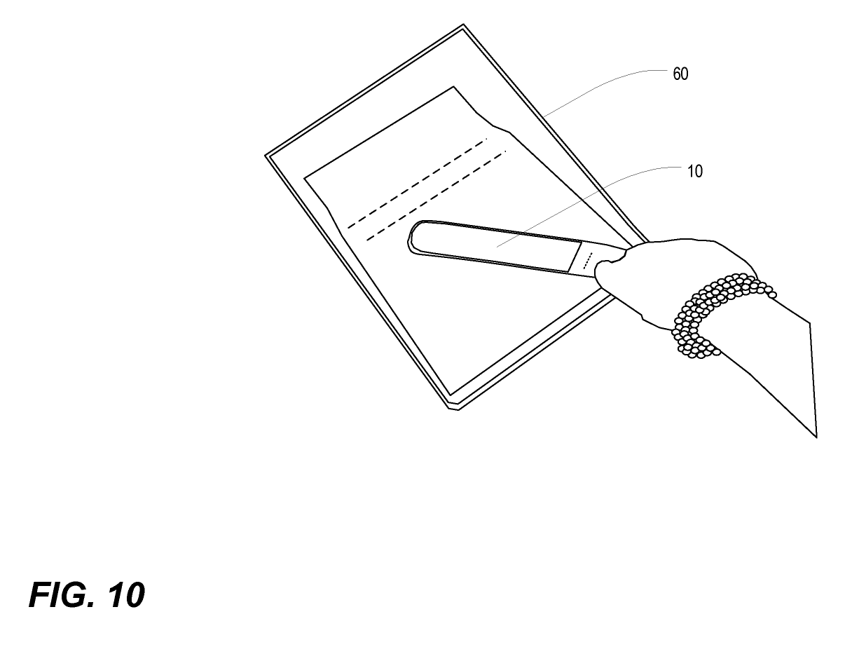

The painting apparatus 10 is then positioned so that the applicator material 34 is on the surface 50 that is at least partially behind the toilet 52, as shown in FIG. 7. The painting apparatus 10 is moved with respect to the surface 50 to cause paint to be applied to the surface 50. The process may be repeated to apply paint to the surface 50 that is along the sides of the toilet 52, as shown in FIG. 8. Once the surface 50 behind the toilet 52 is painted, any protective material 56 may be removed from the toilet 52 and the top 54 of the toilet 52 is replaced, as shown in FIG. 9.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

What is claimed is:

1. A painting apparatus for applying paint to a painting surface within a narrow space, the painting apparatus comprising:
a) a handle portion for grasping by a user,
b) an applicator portion attached to the handle portion and having first and second external surfaces oriented opposite one another; and
c) an applicator material arranged relative to at least one of the first and second external surfaces of the applicator portion for applying paint to the painting surface;
d) wherein the applicator portion is offset from the handle portion so as to permit the user to access and paint the painting surface without the user's hand entering into direct contact with the painting surface.

2. The painting apparatus of claim 1, wherein the applicator portion has a length between about 6 inches and about 36 inches.

3. The painting apparatus of claim 2, wherein the applicator portion has a length between about 12 inches and about 18 inches.

4. The painting apparatus of claim 1, wherein the applicator portion has a width between about 1 inch and about 2 inches.

5. The painting apparatus of claim 1, wherein the applicator portion is formed of a metal-based material.

6. The painting apparatus of claim 5, wherein the metal-based material includes stainless steel.

7. The painting apparatus of claim 1, wherein the applicator material is comprised of foam.

8. The painting apparatus of claim 1, wherein the applicator material is comprised of bristles.

9. The painting apparatus of claim 1, wherein the applicator material is comprised of a fabric material.

10. The painting apparatus of claim 1, wherein the applicator material includes at least two applicator regions each comprised of a different material.

11. The painting apparatus of claim 1, wherein the applicator material is permanently attached to the applicator portion.

12. The painting apparatus of claim 1, wherein the applicator material is removably attached to the applicator portion.

13. The painting apparatus of claim 12, wherein the applicator material is removably attached to the applicator portion with an adhesive.

14. The painting apparatus of claim 12, wherein the applicator material is removably attached to the applicator portion with hook and loop fasteners.

15. The painting apparatus of claim 12, wherein at least a portion of the applicator material is extendable over at least a portion of the applicator portion and is slidable relative to the applicator portion such that sliding the applicator material relative to the applicator portion facilitates attachment or detachment of the applicator material.

16. The painting apparatus of claim 1, wherein the handle portion is offset from the applicator portion by a distance between about 1 inch and about 3 inches.

17. The painting apparatus of claim 1, further comprising at least one rib extending along at least a portion of the length of the applicator portion.

18. A painting apparatus for applying paint to a painting surface within a narrow space, the painting apparatus comprising:
a) a handle portion for grasping by a user,
b) an applicator portion attached to the handle portion and having first and second external surfaces oriented opposite one another;
c) an applicator material arranged relative to at least one of the first and second external surfaces of the applicator portion for applying paint to the painting surface; and
d) a reinforcing member extending along at least a portion of the applicator portion to provide rigidity along the length thereof;
e) wherein the applicator portion is offset from the handle portion so as to permit the user to access and paint the painting surface without the user's hand entering into direct contact with the painting surface.

19. A method of painting a surface to be painted within a narrow space, the method comprising the steps of:
a) providing a painting apparatus having a handle portion and an applicator portion offset from the handle portion, wherein an applicator material is arranged relative to at least one external surface of the applicator portion;
b) immersing at least a portion of the applicator material in a paint reservoir; and
c) positioning the applicator material on the surface to be painted and moving the painting apparatus relative to the surface to be painted so as to cause paint to be applied to the surface to be painted.

20. The method of painting a surface to be painted within a narrow space of claim 19, wherein the painting apparatus is used to paint a surface located at least partially behind a toilet.
